(19) United States
(12) Patent Application Publication
(10) Pub. No.: US 2014/0310208 A1
(43) Pub. Date: Oct. 16, 2014

(54) Facilitating Operation of a Machine Learning Environment

(71) Applicant: MACHINE PERCEPTION TECHNOLOGIES INC., San Diego, CA (US)

(72) Inventors: Ian Fasel, San Diego, CA (US); James Polizo, Santa Cruz, CA (US); Jacob Whitehill, Cambridge, MA (US); Joshua M. Susskind, La Jolla, CA (US); Javier R. Movellan, La Jolla, CA (US)

(73) Assignee: Machine Perception Technologies Inc., San Diego, CA (US)

(21) Appl. No.: 13/860,467

(22) Filed: Apr. 10, 2013

(51) Int. Cl. G06N 99/00

(52) U.S. Cl. CPC G06N 99/005
USPC 706/12

(57) ABSTRACT

Machine learning systems are represented as directed acyclic graphs, where the nodes represent functional modules in the system and edges represent input/output relations between the functional modules. A machine learning environment can then be created to facilitate the training and operation of these machine learning systems.

### BACKGROUND OF THE INVENTION

1. Field of the Invention

This invention relates in part to machine learning environments. It especially relates to approaches that facilitate the training and use of supervised machine learning environments.

2. Description of the Related Art

Many computational environments include a number of functional modules that can be connected together in different ways to achieve different purposes. Each of the functional modules can be quite complex and the different modules may be interrelated. For example, the output of one module may serve as the input to another module. Changes in the first module will then affect the second module.

Furthermore, in machine learning environments, some of these modules undergo training, which itself can be quite complex. In a typical training scenario, a training set is used as input to a learning module. The training set includes input data, and may also contain corresponding target outputs (i.e., the desired output corresponding to the inputs). The learning module uses the training set to adjust the parameters of an internal model (for instance, the numerical weights of a neural network, or the structure and coefficients of a probabilistic model) to meet some objective criterion. Often this objective is to maximize the probabilithy of producing correct outputs given new inputs, based on the training set. In other cases the objective is to maximize the probability of the training set (data and/or labels) according to the model being adjusted. These are just a few examples of objectives a learning module may use. There are many others.

Training a module in and of itself can be quite complex, requiring a large number of iterations and a good selection of training sets. The same module trained by different training sets will function differently. This complexity is compounded if a machine learning environment contains many modules which require training and which interact with each other. It is not sufficient to specify that module A provides input to module B, because the configuration of each module will depend on what training it has received to date. Module A trained by training set 1 will provide a different input to module B, than would module A trained by training set 2. Similarly, the training set for module B will also influence how well module B performs. However, in the case described here, the training set for module B is the output of module A, which is itself subject to training Experimentation with a wide range of variations of modules A and B typically is needed to produce a good overall system. It can become quite complex and time-consuming to conduct and to keep track of the various training experiments and their results.

Therefore, there is a need for techniques to facilitate the training and operation of a machine learning environment.

### SUMMARY OF THE INVENTION

The present invention overcomes the limitations of the prior art by representing machine learning systems (or other systems) as directed acyclic graphs, where the nodes represent functional modules in the system and edges represent input/output relations between the functional modules. A machine learning environment can then be created to facilitate the training and operation of these machine learning systems.

One aspect facilitates the operation of a machine learning environment. The environment includes functional modules that can be configured and linked in different ways to define different machine learning instances. The machine learning instances are defined by a directed acyclic graph. The nodes in the graph identify functional modules in the machine learning instance. The edges entering a node represent inputs to the functional module and the edges exiting a node represent outputs of the functional module. The machine learning environment is designed to receive the graph description of a machine learning instance and then execute the machine learning instance based on the graph description.

In addition, interim and final outputs of executing the machine learning instance can be saved for later use. For example, if a later machine learning instance requires an output that has been previously produced, that output can be retrieved rather than having to re-run the underlying functional modules.

In one implementation, the functional modules are implemented as independent processes. Each module has an assigned socket port and can receive commands and send responses through that port. The functional modules are connected together at run-time as needed.

One example application is emotion detection or smile detection. Functional modules can include face detection modules, facial landmark detection modules, face alignment modules, facial landmark location modules, various filter modules, unsupervised clustering modules, feature selection modules and classification modules. The different modules can be trained, where training is described by directed acyclic graphs. In this way, an overall emotion detection system or smile detection system can be developed.

Other aspects of the invention include methods, devices, systems, applications, variations and improvements related to the concepts described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a pictorial block diagram illustrating a system for automatic facial action coding.

FIG. 2 is a block diagram illustrating a system for smile detection.

FIGS. 3A-C are block diagrams illustrating training of a module.

FIG. 4 is a block diagram illustrating a machine learning environment according to the invention.

FIG. 5 is a directed acyclic graph defining an example machine learning instance.

FIGS. 6A-C are block diagrams illustrating execution of machine learning instances using different architectures.

FIG. 7 illustrates one embodiment of components of an example machine able to read instructions from a machine-readable medium and execute them in a processor (or controller).

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed. For example, various principles will be illustrated using emotion detection systems or smile detection systems as an example, but it should be understood that these are merely examples and the invention is not limited to these specific applications.

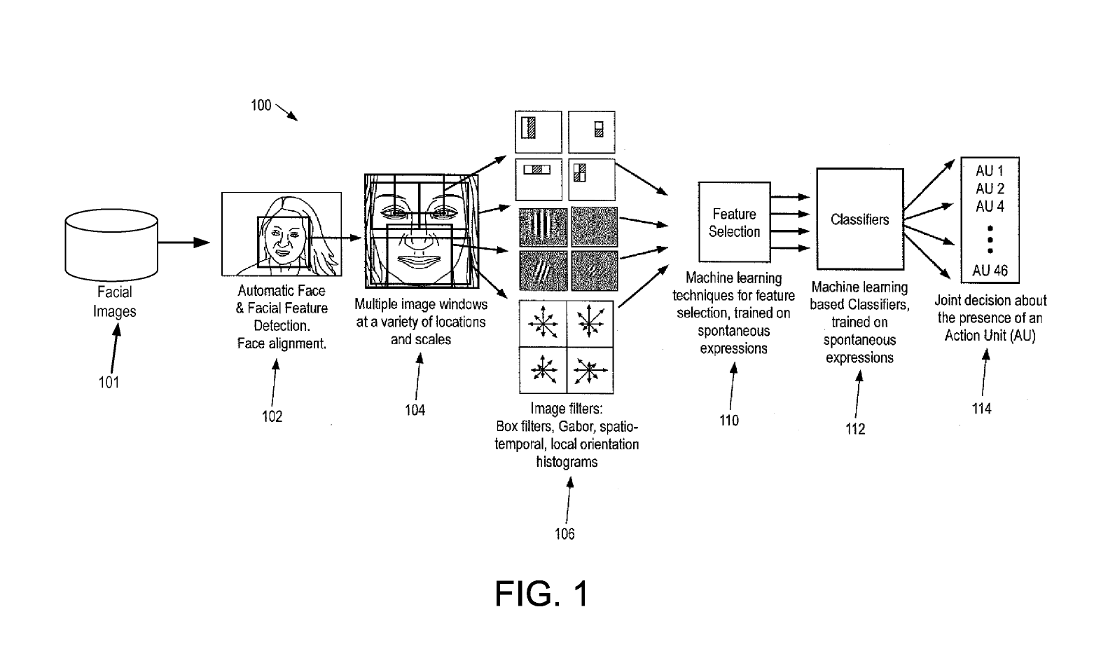

FIG. 1 is a pictorial block diagram illustrating a system for automatic facial action coding. Facial action coding is one system for assigning a set of numerical values to describe facial expression. The system in FIG. 1 receives facial images and produces the corresponding facial action codes. At 101 a source module provides a set of facial images. At 102, a face detection module automatically detects the location of a face within an image (or within a series of images such as a video), and a facial landmark detection module automatically detects the location of facial landmarks or facial features, for example the mouth, eyes, nose, etc. A face alignment module extracts the face from the image and aligns the face based on the detected facial landmarks. For the purposes of this disclosure, an image can be any kind of data that represent a visual depiction of a subject, such as a physical object or a person. For example, the term includes all kind of digital image formats, including but not limited to any binary or other computer-readable data representation of a two-dimensional image.

After the face is extracted and aligned, at 104 a face region extraction module defines a collection of one or more windows at several locations of the face, and at different scales or sizes. At 106, one or more image filter modules apply various filters to the image windows to produce a set of characteristics representing contents of each image window. The specific image filter or filters used can be selected using machine learning methods from a general pool of image filters that can include but are not limited to Gabor filters, box filters (also called integral image filters or Haar filters), and local orientation statistics filters. In some variations, the image filters can include a combination of filters, each of which extracts different aspects of the image relevant to facial action recognition. The combination of filters can optionally include two or more of box filters (also known as integral image filters, or Haar wavelets), Gabor filters, motion detectors, spatio-temporal filters, and local orientation filters (e.g. SIFT, Levi-Weiss).

The image filter outputs are passed to a feature selection module at 110. The feature selection module, whose parameters are found using machine learning methods, can include the use of one or more supervised and/or unsupervised machine learning techniques that are trained on a database of spontaneous expressions by subjects that have been manually labeled for facial actions from the Facial Action Coding System. The feature selection module 110 processes the image filter outputs for each of the plurality of image windows to select a subset of the characteristics or parameters to pass to the classification module at 112. The feature selection module results for one or more face region windows can optionally be combined and processed by a classifier process at 112 to produce a joint decision regarding the posterior probability of the presence of an action unit in the face shown in the image. The classifier process can utilize machine learning on the database of spontaneous facial expressions. At 114, a promoted output of the process 112 can be a score for each of the action units that quantifies the observed “content” of each of the action units in the face shown in the image.

In some implementations, the overall process can use spatio-temporal modeling of the output of the frame-by-frame AU (action units) detectors on sequences of images. Spatio-temporal modeling includes, for example, hidden Markov models, conditional random fields, conditional Kalman filters, and temporal wavelet filters, such as temporal Gabor filters, on the frame by frame system outputs.

In one example, the automatically located faces can be rescaled, for example to 96×96 pixels. Other sizes are also possible for the rescaled image. In a 96×96 pixel image of a face, the typical distance between the centers of the eyes can in some cases be approximately 48 pixels. Automatic eye detection can be employed to align the eyes in each image before the image is passed through a bank of image filters (for example Gabor filters with 8 orientations and 9 spatial frequencies (2:32 pixels per cycle at ½ octave steps). Output magnitudes can be passed to the feature selection module and facial action code classification module. Spatio-temporal Gabor filters can also be used as filters on the image windows.

In addition, in some implementations, the process can use spatio-temporal modeling for temporal segmentation and event spotting to define and extract facial expression events from the continuous signal (e.g., series of images forming a video), including onset, expression apex, and offset. Moreover, spatio-temporal modeling can be used for estimating the probability that a facial behavior occurred within a time window. Artifact removal can be used by predicting the effects of factors, such as head pose and blinks, and then removing these features from the signal.

Note that many of the modules in FIG. 1 are learning modules. For example, the face detection module and facial landmark detection module at 102 may be learning modules. The face detection module may be trained using a training set of facial images and the corresponding known face locations within those facial images. Similarly, the facial landmark detection module may be trained using a training set of facial images and corresponding known locations of facial landmarks within those facial images. Similarly, the face alignment module at 102 and the facial landmark location module 104 may also be implemented as learning modules to be trained. The various filters at 106 may be adaptive or trained. Alternately, they may be fixed a priori to provide a specific feature set, with the feature selection module at 110 being trained to recognize which feature sets should be given more or less weight. Similar remarks apply to the modules at 112 and 114. Thus, many of the modules shown in FIG. 1 may be subject to training and, since earlier modules provide inputs to later modules, the training of the later modules will depend on the training of the earlier modules. Since training usually requires a fair amount of experimentation, the training of the machine learning instance shown in FIG. 1 can be quite complex.

FIG. 1 is just one example of a machine learning system. Other examples will be apparent. For example, see U.S. patent application Ser. No. 12/548,294, which is incorporated herein by reference in its entirety.

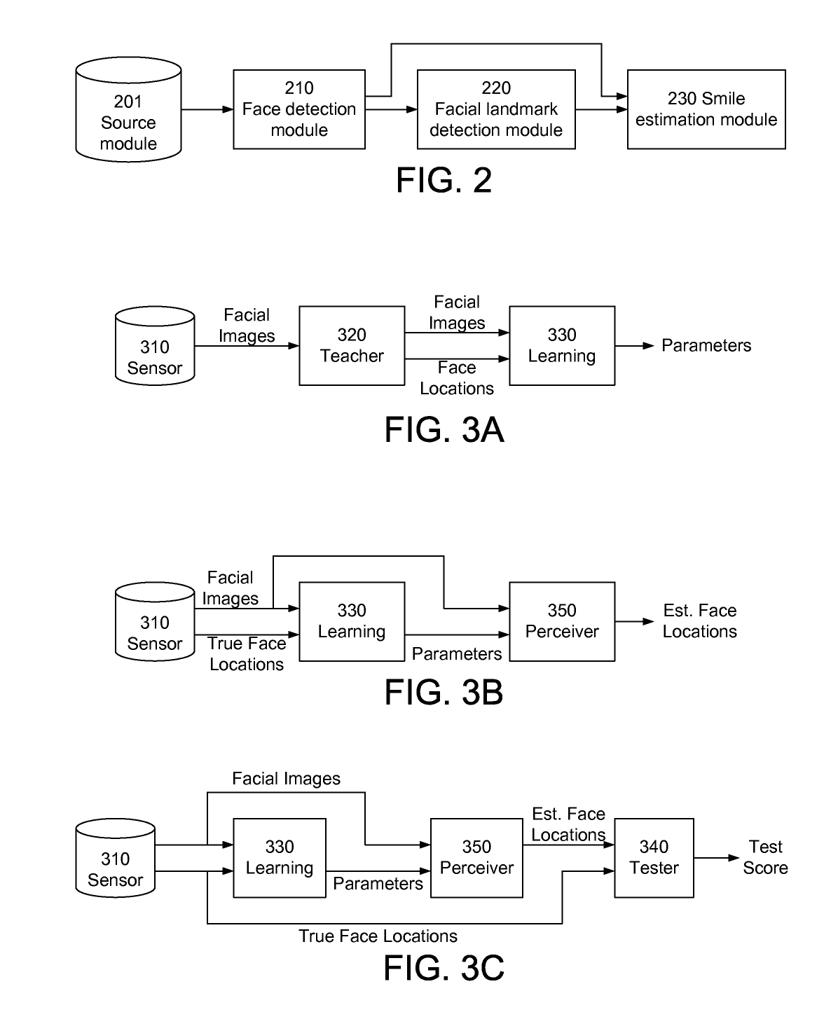

FIG. 2 shows a simpler system which will be used for purposes of illustration in this disclosure. FIG. 2 is a block diagram illustrating a system for smile detection. Other types of emotion detection could also be used. The smile detection system in FIG. 2 includes just four modules. A source module 201 provides facial images to the rest of the system. A face detection module 210 receives facial images as inputs and produces image patches of faces as output. A facial landmark detection module 220 receives the image patches of faces as inputs and outputs the location of facial landmarks (e.g., left and right medial and nasal canthus, left and right nostril, etc.) in those patches. A smile estimation module 230 receives both image patches from a face and the location of facial landmarks as input and outputs an estimate of whether or not the input face has a smiling expression. Thus, the complete smile detection system depends on the joint operation of modules 210-230. Experimentation with a wide range of variations of these three different modules (i.e., training the modules) is desirable to produce a good smile detection system. Note that these experiments have a directed graph structure. For example, variations of module 210 can affect the output of module 220, but variations of module 220 cannot affect the output of module 210. Variations of modules 210 and 220 affect module 230 but variations of module 230 do not affect modules 210 or 220.

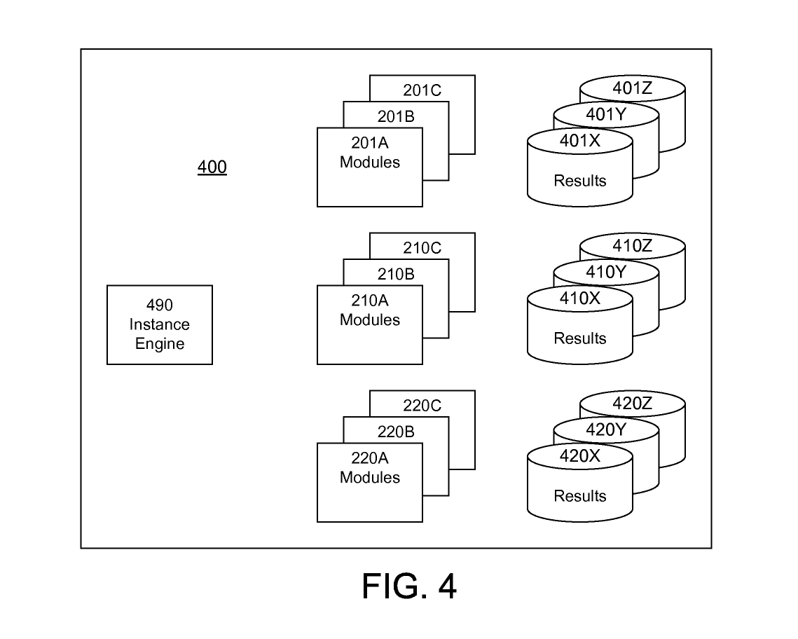

With respect to machine learning systems, modules can often be classified according to the role played by that module: sensor, teacher, learner, perceiver, and tester for example. FIGS. 3A-C illustrate these roles, using the face detection module 210 from FIG. 2. The goal is to train the face detection module 210 to predict face locations from received facial images. FIG. 3A illustrates supervised learning through use of a training set. FIG. 3B illustrates operation after learning is sufficiently completed. FIG. 3C illustrates testing to determine whether the supervised learning has been successful.

Beginning with FIG. 3A, sensor modules provide initial data as input to other modules. In the example of FIG. 3, the sensor module 310 provides facial images. Teacher modules provide the supervised learning. They receive input data and provide the corresponding training outputs. In FIG. 3A, the teacher module 320 receives facial images from sensor module 310 and provides the “right answer,” i.e., the face location for each facial image. The teacher module 320 may calculate the training output or it may obtain the training output from another source. For example, a human may have manually determined the face location for each facial image, and the teacher module 320 simply accesses a database to return the correct location for each facial image. The learning module 330 is the module being trained by the teacher module 320. In this case, the learning module 330 is learning to estimate face locations from facial images. In many cases, the learning module 330 includes a parameterized model of the task at hand, and the learning process uses the training set to adjust the values of the numerical or categorical or structural parameters of the model. In some cases, including the example of FIG. 3A, the learning module 330 outputs the model parameters.

Once the learning module has produced a set of model parameters, another module (or the same module used in a different mode) 350 can use those parameters to perform tasks on other input data, as shown in FIG. 3B. This module, which will be referred to as a perceiver module 350, takes two inputs: facial images, and parameters that have been trained by learning module 330. In FIG. 3B, the sensor module 310 provides new facial images to the perceiver module 350, and the learning module 330 provides new model parameters to the perceiver module 350 (teacher module 320 is omitted for clarity in FIG. 3B). Perceiver module 350 outputs the estimated face locations.

In FIG. 3C, a tester module 340 determines how well the learning module 330 has learned parameters for a face detector. The sensor module 310 provides facial images to the perceiver module 350, while the learning module 330 provides learned parameters for face detection, which were trained by teacher module 320 (not shown in FIG. 3C). Perceiver module 350 outputs its estimate of face locations. The tester module 340 receives the correct locations (or other labels) from sensor module 310 and the predicted locations (or other labels) from perceiver module 350. The tester module 340 compares them. In this way, it can determine how well the learning module 330 trained a face detector.

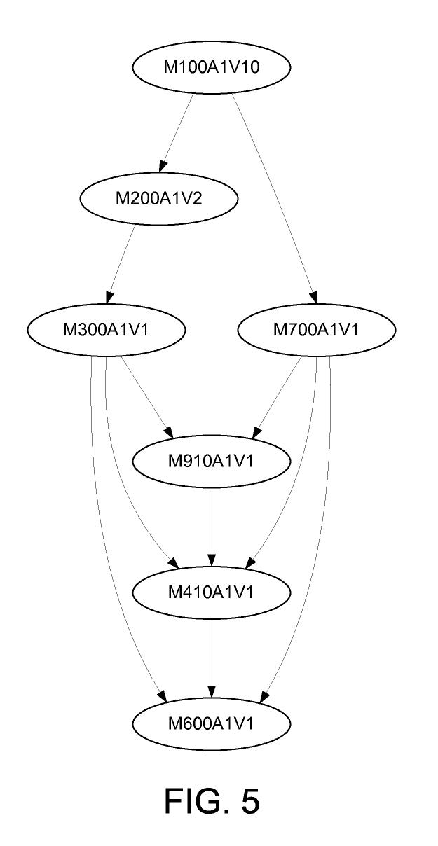

As illustrated by the examples of FIGS. 1-3, the construction, training and operation of a machine learning system can be quite complex. FIG. 4 is a block diagram illustrating one approach to facilitate these tasks. The system 400 shown in FIG. 4 will be referred to as a machine learning environment. It is an environment because it is more than just a single machine learning system (such as the systems shown in FIG. 1 or FIG. 2). Rather, it contains various functional modules and mechanisms for specifying different types of training (i.e., for running different “experiments”) on different modules or sets of modules. It also contains mechanisms for constructing different operational machine learning systems from the modules (including differently trained modules). For convenience, the term “machine learning instance” will be used to refer to a system constructed from functional modules from the machine learning environment. Thus, the examples shown in FIGS. 1 and 2 are machine learning instances. Each of the examples shown in FIGS. 3A-3C is also a machine learning instance. Note that the machine learning instances in FIGS. 3A-3C use modules from a common machine learning environment.

Returning to FIG. 4, the machine learning environment 400 includes functional modules 2xx. However, there may be variations of the same functional module. Thus, functional modules may be further identified by any number of attributes. The types of attributes that are used may differ from one module to the next. Using the smile detection example of FIG. 2, one of the functional modules may be a sensor module 201 that provides facial images to other modules. There may be variations of this module, labeled 201A,B,C, etc. in FIG. 4, depending on attributes of which set of facial images is used, what type of preprocessing if any is performed, which output format for the images, which version of the software code is used, etc. In FIG. 4, the different versions are labeled A,B,C, etc. for simplicity, but more complex labeling systems may be used. For example, there may be three labels: one identifying the attribute of which set of images, one identifying the attribute of which version of the software code, and one specifying the attribute of which type of preprocessing and output format and resolution.

Another module in the machine learning environment may be the face detection module with variants 210A,B,C, etc. Two attributes for this module may be which version of the software code is used and what numerical values are used for the parameters in the module. The parameter values may be defined by specifying the values, or by specifying the training that led to the values.

In addition, to various modules, the machine learning environment can also contain results from machine learning instances. When a machine learning instance is executed, it will usually produce some sort of result. In FIG. 3A, the machine learning instance produces a set of parameters as its final result. It also produces interim results, such as the face locations provided by the teacher module 320. These results can be saved and form part of the machine learning environment. In FIG. 4, they are labeled as results 401X,Y,Z, etc.; 410X,Y,Z, etc. and so on. Note that there can be many more results files than variations, because a results file depends both on the module's variation label and the inputs to that module. For instance, 420X may have been produced by module 220A when taking 210A as input, while 420Y may have been produced by by module 220A when taking 210B as input. In one implementation, the label for a results file is derived from the unique chain of precursor modules used to produce that result.

One advantage of saving these results is that this can save time. For example, suppose face detection module 210 takes 10 hours to produce an output. This output becomes input to smile estimation module 230. Let's say that 20 experiments are run on smile estimation module 230 in order to train the module. This means the input from face detection module 210 would be required 20 times, once for each experiment. It will save significant time if the output of module 210 is cached for use with module 230, rather than having to repeat the 10-hour run of module 210 twenty times.

The machine learning environment 400 also includes an instance engine 490. The instance engine 490 receives and executes commands that define different machine learning instances. For example, the instance engine 490 might receive a command to execute the machine learning instance of FIG. 3A. The instance engine 490 accesses the modules and results, in order to execute this machine learning instance. It might then receive a command to execute the machine learning instance of FIG. 3B, and then the machine learning instance of FIG. 3C. The instance engine 490 makes use of the available resources in the machine learning environment in order to carry out the commands.

The machine learning instances are defined by directed acyclic graphs. A directed acyclic graph includes nodes and edges connecting the nodes. The nodes identify the functional modules, including attributes to identify a specific variant of a module. The edges entering a node represent inputs to the functional module, and the edges exiting a node represent outputs produced by the functional module. The instance engine 490 executes the machine learning instance defined by the graph.

The machine learning instances in FIGS. 2-3 can be represented as directed acyclic graphs, as follows. Each box in a figure is a node in the graph. The arrows in the figures are edges in the graph. The machine learning instance of FIG. 1 can also be represented as a directed acyclic graph.

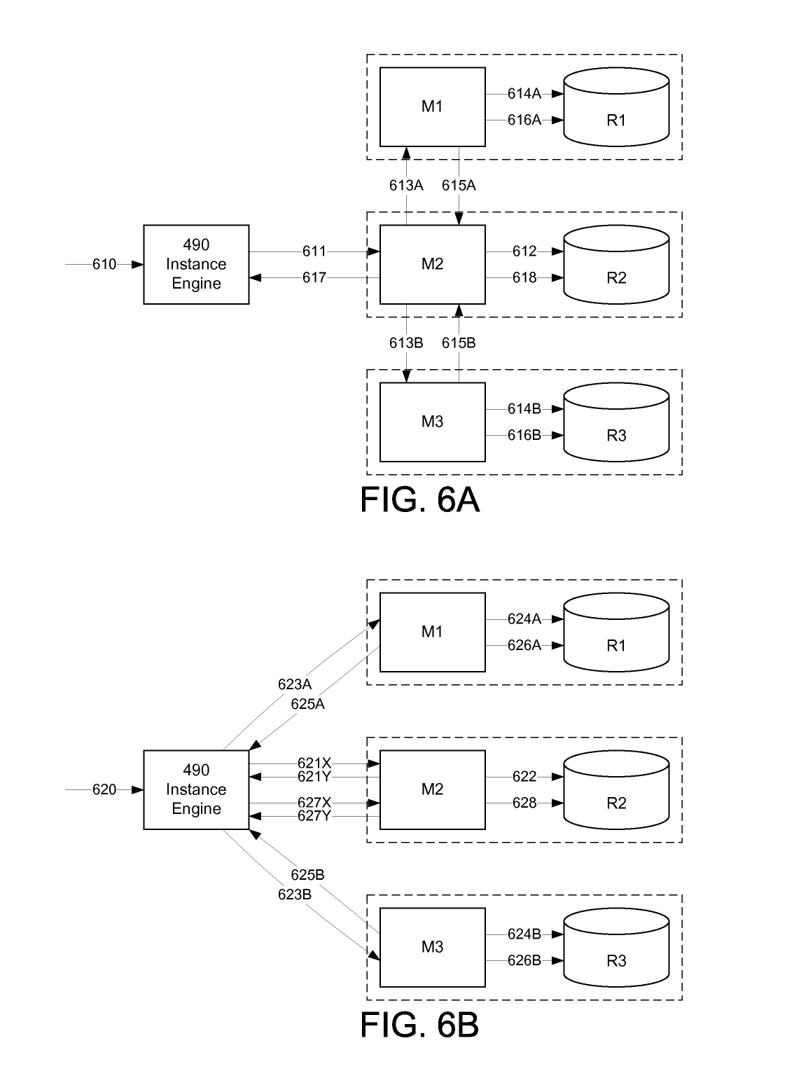

FIG. 5 is a directed acyclic graph defining another machine learning instance for training, running, and testing a face detector. This example uses the following syntax. The modules are identified by a string of the form MxAyVz, where x is an integer representing the Module ID and y and z are integers representing two attributes that will be referred to as the A-attribute and the V-attribute. So the first module M100A1V10 is module M100, with attributes of A1 and V10. The attributes A1 and V10 define which variant of module M100 is specified.

The module M100 is a database query module (a type of sensor module) which provides data for later use by modules. Module M200 splits the data into cross-validation folds for benchmarking experiments. Module M300 selects which folds will be used for training and which for testing. Module M910 is a learning module for the face detector. It receives the output from M300, which identifies the training set but does not provide the actual training set. It also receives the output from module M700, which is a teacher module for the face detector. Module M700 converts the raw data from M100 into a training set usable by module M910. The learning module M910 outputs a set of numerical parameters. Module M410 runs the face detector, using the parameters from module M910, on the test set of data (as defined by module M300). Module M600 benchmarks the face detector on yet another subset of the data.

FIG. 5 is a graphical representation of the acyclic graph. The graph can also be represented in other forms, for example text forms. In one syntax, modules are represented by the MxAyVz syntax, and edges are represented by periods. For example, a machine learning instance which is a simple chain of modules can be represented as MxnAynVzn . . . Mx2Ay2Vz2.Mx1Ay1Vz1, where x1,x2, . . . , xn,y1,y2, . . . , yn,z1,z2, . . . , zn are integers representing the module ID and its A- and V-attributes. The formula is read right-to-left. The rightmost module (i.e., module Mx1) is the source module, that sends its output to module Mx2, which sends its output to Mx3, etc. The leftmost module Mxn is the final module in the chain.

For example, the formula M15A42V11.M2A6V8.M23A2V4. describes an experiment using three modules: M15, M2 and M23. Module M23 is run with attributes A2 and V4. Its output goes to module M2, run with attributes A6 and V8. This output goes to module M15, run with attributes A42 and V11. As another example, the formula M1A1V1.M1A1V1. describes a machine learning instance using the same module used twice. Note while the two modules have identical module IDs and parameters, they are logically distinct.

Parenthesis can be used to implement branching in the graph. The formula M4A1V1.(M3A2V1.)(M2A1V1.) tells us that module M4 receives input from both modules M3 and M2. Since modules M3 and M2 have no common ancestors, they can be run independently of each other. When the outputs of the two modules are ready, then module M4 operates on them. As another example, the formula M4A1V1.(M3A2V1.M1A1V1.)(M2A1V1.M1A1V1.) tells us that module M4 receives input from modules M3 and M2. Module M3 receives input from module M1, and module M2 also receives input from module M1.

Text may be more convenient for machines, such as the instance engine 490, while a graphical representation may be easier for humans. Thus, the directed acyclic graph may be represented graphically, as shown in FIG. 5, but then converted to text form for use in the machine learning environment. The graph of FIG. 5 converts to M600A1V1.(M700A1V1.M100A1V10.)(M300A1V1.M200A1V2.M100A1V10.)(M410A1V1.(M910A1V1.(M700A1V1.M100A1V10.)(M300A1V1.M200A1V2.M100A1V10.))(M700A1V1. M100A1V10.)(M300A1V1.M200A1V2.M100A1V10.)).

An example implementation of a machine learning environment is referred to as CCI. In this implementation, each module is an independent process running on a host. Each module has an assigned socket port and can receive commands and send responses through that port. For example, suppose module M373 is on port 7073 of the localhost machine. We can type “telnet localhost 7073” and then send a command like “CCI list” for the module to execute. The modules are dynamically connected to each other at run time to configure an experiment. There are two types of CCI sockets command: module-level commands and network-level commands.

Module-level commands are commands that affect only the CCI module assigned to the port where the command is sent. The following are examples of module-level commands:
CCI help: Provides a list of valid commands.
CCI list: Provides a list of experiments this module can run. For example, the response to CCI list may be M23A2V1., M23A4V1., M64A1V1. meaning that this module can run the module M23 with attributes A2V1, A4V1, and A1V1.
Shutdown: Shuts down the module.
CCI BasePort set: The base port is the starting point of module port range. When you change the base port, you are telling the running module how to find other modules. You are not telling it to change its own IP address.
CCI CachePermissions
CCI CheckPending
CCI CommandScript
CCI ConnectTimeout
CCI CopyExternal
CCI EnableMCP
CCI ExternalCache
CCI LocalCache
CCI MaxAge

The “CCI do” command is sent to a specific module but it is a network-level command. It is network-level, in the sense that it may affect other modules in the CCI network (i.e., in the machine learning environment). The syntax for this command is
CCI do CCI_Formula: This means execute the machine learning instance defined by CCI_Formula, where CCI_Formula is the text description of the machine learning instance using the syntax described above.
   There are several possible responses:
RUNNING: Indicates that the module is processing the request and saving it into a results file.
WAITING: Indicates that the module is waiting for a resource (e.g., RAM).
PENDING: Indicates that the module is calling the predecessor modules that provide the necessary input to run the experiment.
MISSING: Indicates that the module attempted to fetch the result from cache but it was not found in cache and it is not in process.
UNAVAILABLE: Indicates that the requested result is not available and cannot be produced.
FAIL: Indicates an internal error.
ABORT: Indicates a precursor module returned an error before the final result was produced.
<Results File Name>: Indicates that the module already had a file with the result for the experiment. So rather than running the experiment again, it will simply retrieve the previously cached results.
   The outcome of running the “CCI do” command is that the module creates a results file, or uses an existing results file and passes it to the successor modules in the CCI_Formula, or returns an error.

For example, suppose a CCI network includes three modules: M1, M2 and M3. Suppose we open the socket for M3 and send it the following command
CCI do M2A1V1.M1A1V1.
   When module M3 receives this command it realizes that it cannot execute it by itself so it sends the command to module M2. Module M2 realizes that in order to complete the command, it first needs for module M1 to run experiment M1A1V1. (or retrieve results from previously run experiment M1A1V1.). After module M1 completes experiment M1A1V1., then module M2 takes the results of the experiment as input and runs experiment M2A1V1.M1A1V1.

The output of a “CCI do” command is a collection of files with the results of the overall experiment described by CCI_Formula as well as the interim results of the sub experiments needed to complete the overall experiment. For example, the command
CCI do M2A1V1.M4A2V6.M3A2V1.
   produces three result files named:
M3A2V1.
M4A2V6.M3A2V1.
M2A1V1.M4A2V6.M3A2V1.
   These files store the results of the experiments described by the CCI formula interpretation of the file names.

As another example, the command
CCI do M2A1V1.(M4A2V6.M3A2V1.)(M1A2V2)
   produces the result files named:
M1A2V2.
M3A2V1.
M4A2V6.M3A2V1.
M2A1C1.M4A2V6.M3A2V1.
M2A1V1.(M4A2V6.M3A2V1.)(M1A2V2).
   These files store the results of the experiments described by the CCI formula interpretation of the file names.

When a module executes a “CCI do” command it looks at its cache of files with past experimental results and decides which sub experiments it needs to run and which sub experiments it does not need to run because the results are already known, i.e., a file for that experiment already exists. For example, suppose we run the command
CCI do M2A1V1.M4A2V6.M3A2V1.
   and the results file M4A2V6.M3A2V1. already exists. When module M4 receives the request for M4A2V6.M3A2V1., it will simply take the results file of that experiment and pass it to module M2 rather than re-running it. Module M2 will take the file, and run with attributes A1 and V1 to complete the experiment and store the results on file M2A1V1.M4A2V6.M3A2V1.

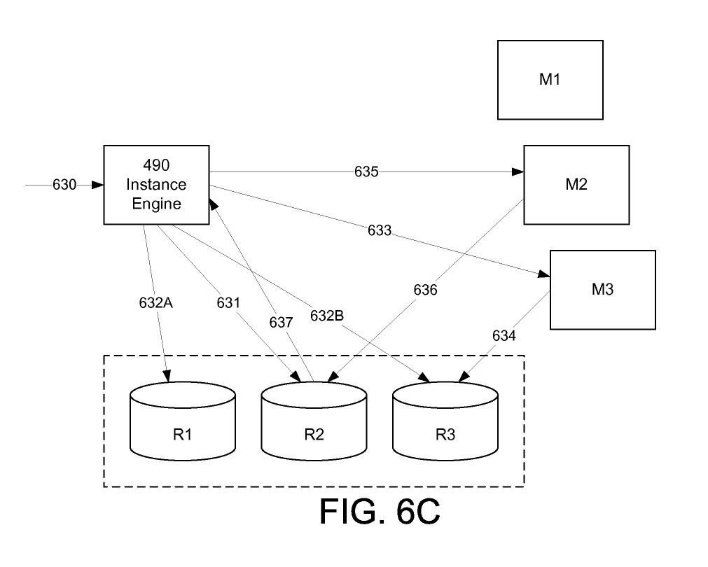

The above is just one example implementation. Other implementations will be apparent. FIGS. 6A-6C show some examples, which will be illustrated using the command
CCI do M2A1V1.(M3A2V1.)(M1A2V2.).

The architecture of FIG. 6A is similar to the one described above. The instance engine 490 and each of the modules M1-M3 is implemented as independent processes. Each module M1-M3 creates and has access to the results R1-R3 that it generates. The CCI command is executed as follows. The instance engine 490 receives 610 the command and sends 611 it to module M2. Module M2 checks 612 for the result M2A1V1.(M3A2V1.)(M1A2V2.). If present, then this experiment has been run before. If not, the module M2 requests 613A M1A2V2. from module M1 and requests 613B M3A2V1. from module M3. Each module M1,M3 checks 614A,B among its respective results. Each module then either retrieves the result or runs the experiment to produce the result. These interim outputs M1A2V2. and M3A2V1. are returned 615A,B to module M2. They are also saved 616A,B locally by module M1,M3 if they did not previously exist. Module M2 executes the machine learning instance M2A1V1.(M3A2V1.)(M1A2V2.) and returns 617 the result to the instance engine 490. This final result is also saved 618 locally by module M2 for possible future use.

The architecture of FIG. 6B is similar to the one in FIG. 6A, except that control is centralized in the instance engine 490 rather than distributed among the modules. In FIG. 6A, the modules could communicate directly with each other. In FIG. 6B, each module communicates with the instance engine 490 and not with the other modules. The CCI command is executed as follows. The instance engine 490 receives 620 the command and sends 621X it to module M2. Module M2 checks 622 for the result M2A1V1.(M3A2V1.)(M1A2V2.). If present, then this experiment has been run before. If not, module M2 communicates 621Y this to instance engine 490. The instance engine 490 then requests 623A M1A2V2. from module M1 and requests 623B M3A2V1. from module M3. Each module M1,M3 checks 624A,B among its respective results. Each module then either retrieves the result or runs the experiment to produce the result. These interim outputs M1A2V2. and M3A2V1. are returned 625A,B to instance engine 490. They are also saved 626A,B locally by module M1,M3 if they did not previously exist. Instance engine 490 forwards 627X the interim results to module M2. Module M2 executes the machine learning instance M2A1V1.(M3A2V1.)(M1A2V2.)., and returns 627Y the result to the instance engine 490. This final result is also saved 628 locally by module M2 for possible future use.

In a variation of this approach, the instance engine 490 first queries which of the interim results already exists. For example, it queries module M1 whether M1A2V2. exists among the results R1, queries module M2 for M2A1V1.(M3A2V1.)(M1A2V2.)., and queries module M3 for M3A2V1. Based on the query results, the instance engine 490 can determine which machine learning instances must be executed versus retrieved from existing results and can then make the corresponding requests.

In the architecture of FIG. 6C, the results R1-R3 are shared by the modules M1-M3 and the instance engine 490. In this architecture, the CCI command can be executed as follows. The instance engine 490 receives 630 the command. It queries 631 whether result M2A1V1.(M3A2V1.)(M1A2V2.). already exists. If present, then this experiment has been run before, and the results can be retrieved and presented to the user. If not, the instance engine 490 then queries 632A,B whether M1A2V2. and M3A2V1. exist. Assume that M1A2V2. exists but M3A2V1. does not. The instance engine 490 requests 633 that module M3 execute machine learning instance M3A2V1., which it does and saves 634 the result among results R3. At this point, the precursor instances M1A2V2. and M3A2V1. both exist. The instance engine 490 then requests 635 module M2 to execute the machine learning instance M2A1V1.(M3A2V1.)(M1A2V2.). Module M2 does so and saves 636 the result. The instance engine 490 retrieves 637 the result for display to the user.

Although the detailed description contains many specifics, these should not be construed as limiting the scope of the invention but merely as illustrating different examples and aspects of the invention. It should be appreciated that the scope of the invention includes other embodiments not discussed in detail above. For example, machine learning environments and their components can be implemented in different ways using different types of compute resources and architectures. For example, the instance engine might be distributed across computers in a network. It may also create replicas of modules on different computers in a network. It may also include a load balancing mechanism to increase utilization of multiple computers in a network. The instance engine may also launch modules on-the-fly as needed, rather than requiring that all modules be running at all times. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

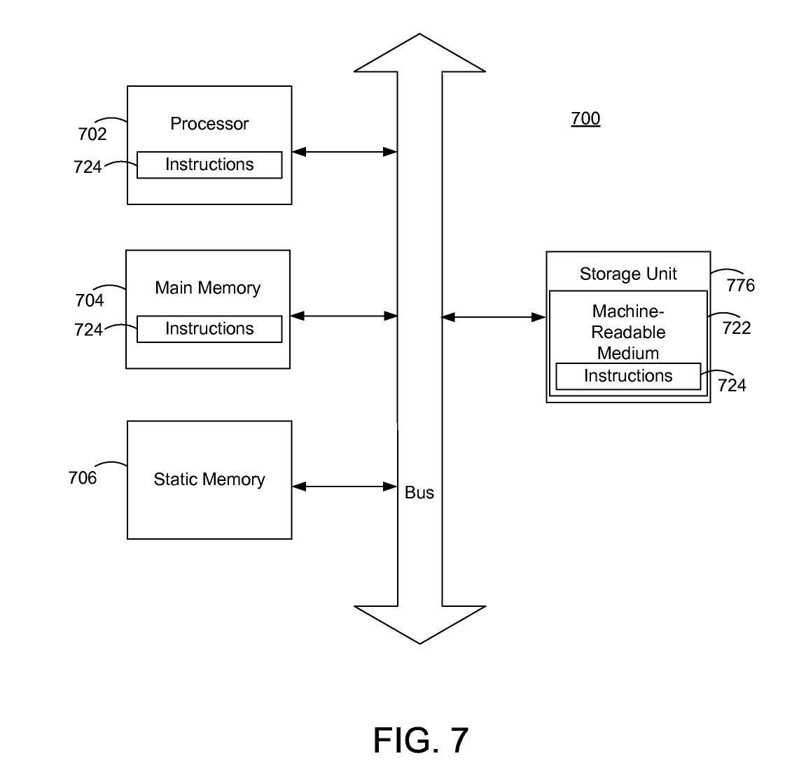

FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), a main memory 704, a static memory 706, and a storage unit 716 which are configured to communicate with each other via a bus 708. The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

The term “module” is not meant to be limited to a specific physical form. Depending on the specific application, modules can be implemented as hardware, firmware, software, and/or combinations of these, although in these embodiments they are most likely software. Furthermore, different modules can share common components or even be implemented by the same components. There may or may not be a clear boundary between different modules.

Depending on the form of the modules, the “coupling” between modules may also take different forms. Software “coupling” can occur by any number of ways to pass information between software components (or between software and hardware, if that is the case). The term “coupling” is meant to include all of these and is not meant to be limited to a hardwired permanent connection between two components. In addition, there may be intervening elements. For example, when two elements are described as being coupled to each other, this does not imply that the elements are directly coupled to each other nor does it preclude the use of other elements between the two. For instance, modules may be coupled in that they both send messages to and receive messages from a common interchange service on a network.

What is claimed is:

1. A computer-implemented method for facilitating operation of a machine learning environment, the environment comprising functional modules that can be configured and linked in different ways to define different machine learning instances, the method comprising:
receiving a directed acyclic graph defining a machine learning instance, the directed acyclic graph containing nodes and edges connecting the nodes, the nodes identifying functional modules, the edges entering a node representing inputs to the functional module and the edges exiting a node representing outputs of the functional module; and
executing the machine learning instance defined by the acyclic graph.

2. The method of claim 1 further comprising:
saving a final output of the machine learning instance.

3. The method of claim 1 further comprising:
saving an interim output of the machine learning instance.

4. The method of claim 1 wherein the step of executing the machine learning instance comprises:
identifying that an output of a component of the machine learning instance has been previously saved; and
retrieving the saved output rather than re-executing the component.

5. The method of claim 1 wherein the step of executing the machine learning instance comprises:
linking output of one functional module in the machine learning instance to input of a next functional module of the machine learning instance at run-time.

6. The method of claim 1 wherein the functional modules communicate through a shared file system.

7. The method of claim 1 wherein the nodes identify functional modules and at least one attribute for at least one functional module.

8. The method of claim 7 wherein the at least one attribute is a version number for a software code for the functional module.

9. The method of claim 7 wherein the functional module contains numerical, categorical, or structural parameters determining by supervised learning, and the at least one attribute identifies values for the numerical parameters.

10. The method of claim 1 wherein at least one functional module is a sensor module that provides initial data as input to other functional modules for processing.

11. The method of claim 1 wherein at least one functional module is a teacher module that receives input data and provides corresponding training outputs, the input data and corresponding training outputs forming a training set for training a parameterized model implemented by other functional modules.

12. The method of claim 1 wherein at least one functional module is a learning module that receives a training set as input and undergoes learning of a parameterized model based on the training set.

13. The method of claim 12 wherein the learning module outputs numerical, categorical, or structural parameters determined by learning for a parameterized model.

14. The method of claim 1 wherein at least one functional module is a perceiver module that receives data as input and applies a parameterized model to produce corresponding outputs.

15. The method of claim 14 wherein the perceiver module further receives numerical parameters for the parameterized model as input.

16. The method of claim 15 wherein at least one functional module is a tester module that receives inputs from the perceiver model and evaluates an accuracy of the perceiver module.

17. The method of claim 1 wherein the machine learning environment contains sufficient functional modules to define a machine learning instance that implements emotion detection from facial images.

18. The method of claim 17 wherein at least one of the modules is a face detection module that identifies face location within facial images.

19. The method of claim 17 wherein at least one of the modules is a facial landmark detection module that identifies locations of facial landmarks within an identified face.

20. The method of claim 17 wherein at least one of the modules is an emotion detection module that outputs an indication of emotion based on identified facial landmarks within a face.

21. The method of claim 1 wherein the machine learning environment contains sufficient functional modules to define a machine learning instance that implements smile detection from facial images.

22. The method of claim 21 wherein at least one of the modules is a smile detection module that outputs an estimate of whether a smile is present based on identified facial landmarks within a facial image.

23. The method of claim 1 wherein the step of receiving the directed acyclic graph comprises receiving a text string representing the directed acyclic graph.

24. The method of claim 1 wherein the step of receiving the directed acyclic graph comprises receiving a graphical representation of the directed acyclic graph.

25. A tangible computer readable medium containing instructions that, when executed by a processor, execute a method for facilitating operation of a machine learning environment, the environment comprising functional modules that can be configured and linked in different ways to define different machine learning instances, the method comprising:
receiving a directed acyclic graph defining a machine learning instance, the directed acyclic graph containing nodes and edges connecting the nodes, the nodes identifying functional modules, the edges entering a node representing inputs to the functional module and the edges exiting a node representing outputs of the functional module; and
executing the machine learning instance defined by the acyclic graph.

26. A tool for facilitating operation of a machine learning environment, the environment comprising functional modules that can be configured and linked in different ways to define different machine learning instances, the method comprising:
means for receiving a directed acyclic graph defining a machine learning instance, the directed acyclic graph containing nodes and edges connecting the nodes, the nodes identifying functional modules, the edges entering a node representing inputs to the functional module and the edges exiting a node representing outputs of the functional module; and
means for executing the machine learning instance defined by the acyclic graph.
